(19) United States
(12) Patent Application Publication
(10) Pub. No.: US 2009/0222591 A1
(43) Pub. Date: Sep. 3, 2009

(54) Method and Apparatus for Selecting an Access

(75) Inventor: Fan Yang, Helsinki (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/039,502

(22) Filed: Feb. 28, 2008

(51) Int. Cl. G06F 15/16

(52) U.S. Cl. 709/250

(57) ABSTRACT

A method and apparatus are disclosed according to which a programmable access selector comprising at least one defined characteristic and at least one defined method are applied with each other, wherein at least one access from among a plurality of available accesses is selected responsive to the application.

### BACKGROUND

In recent years mobile devices, such as for example mobile telephones or mobile multimedia devices, have been furnished with multiple access interfaces such as, for example, general packet radio service (GPRS), wireless local area network (WLAN), wideband code division multiple access (WCDMA) and other accesses both wire-line based and wireless. This has enabled mobile devices to access services via a number of different technologies and networks. For the sake of simplicity, this will be referred to as multi-access hereinafter.

The purpose of multi-access is to provide advanced utilization of network resources. For example, accessing the Internet may be advantageous via WLAN access if such is available and otherwise e.g. a GPRS access may be used. As another example, accessing a network via WLAN may provide cheaper service whereas accessing the same network via WCDMA may provide higher quality of service (QoS). With a multi-access arrangement a user may obtain flexible access to resources according to his priorities such as QoS or price.

### SUMMARY

According to an embodiment of the present invention, there is provided an apparatus comprising a programmable access selector and a processor. The programmable access selector comprises at least one characteristic of at least one access and at least one method to select at least one access from among available accesses. The programmable access selector is configured to select from among available accesses based at least in part on said at least one method and said at least one characteristic.

According to another embodiment of the present invention, there is provided a method for selecting at least one from among available accesses. The method comprises obtaining a list of at least one of a plurality of available accesses, comparing at least one defined characteristic to characteristics of the plurality of available accesses and applying at least one method defined in a programmable access selector to the plurality of available accesses, wherein at least one access from the plurality of available accesses is selected responsive to applying the at least one method with the comparison.

According to yet another embodiment of the present invention, there is provided a method for updating an existing programmable access selector, which comprises determining that an update is possible, triggering an update, receiving at least a part of a new programmable access selector and replacing at least part of said existing programmable access selector with the received at least part of said new programmable access selector.

In an exemplary embodiment, the programmable access selector may be arranged to be executed without being compiled, for example by defining it with a script language such as XML (extended markup language).

The programmable access selector may be arranged to be updatable, for example by using over-the-air (OTA) updating in a mobile device. The updating may be done responsive to the mobile device attaching to an access, such as for example a new type of access with which the mobile device has not attached before.

### BRIEF DISCUSSION OF THE DRAWINGS

FIG. 1 illustrates an example of an apparatus capable of using embodiments of the present invention;

FIG. 2 illustrates an example of a programmable access selector;

FIG. 3 is a flowchart of a process for selecting an access according to an exemplary embodiment of the present invention;

FIG. 4 illustrates a flowchart of an exemplary embodiment of a process to select an access; and

FIG. 5 is a flowchart of a process for updating a programmable access selector according to an exemplary embodiment of the present invention.

### DETAILED DESCRIPTION

In use cases where a plurality of access types is available, selecting an optimal access for use may be complicated because the available accesses may have different characteristics. For example, for downloading email to a mobile device, it is viable to use a WLAN access, a GPRS access or a WCDMA access which may all be available. Furthermore, if a WLAN access type is decided on there may be several WLAN accesses available with varying characteristics (price, capacity etc).

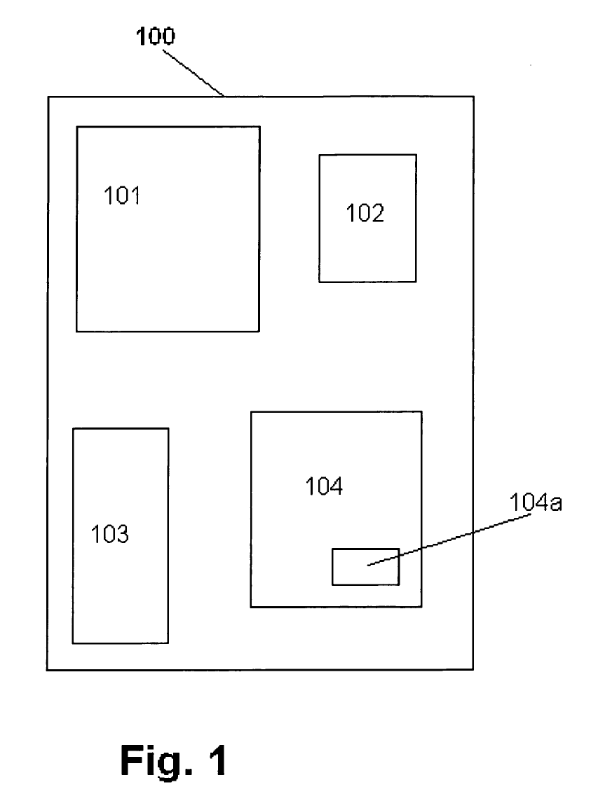

FIG. 1 illustrates an exemplary apparatus, for example a mobile device 100, capable of utilizing an embodiment of the present invention. It should be appreciated that whereas a mobile device encounters the access selection task more often, non-mobile devices may equally benefit from the access selection process described herein.

The device 100 may comprise a user interface means, e.g. a user interface 101, which may allow a user to interact with the device and input commands and/or messages. The user interface means may be implemented using a display and keypad, voice control or other means. The device may also comprise processing means, e.g. a processor 102, which may be configured to execute programs stored in memory means. The processing means may be implemented by various technical processing means, such as for example by employing a DSP processor, a microprocessor, a microcontroller, an application-specific integrated circuit (ASIC), a field-programmable gate array (FPGA) or similar apparatus. The memory means, e.g. memory 104, may be implemented by various data storage means, for example by solid-state, magnetic, holographic, opto-electronic or other kind of memory capable of storing digital information. The memory means comprises a programmable access selector 104a arranged in a form capable of being executed on the processing means. The device 100 further comprises a interface means, e.g. an interface 103, configured to communicate using a plurality of different access types, such as for example WCDMA, WLAN, GPRS, global system for mobile communication (GSM), worldwide interoperability for microwave access (WiMAX), and/or 2G/3G/4G access types and/or the like. Also satellite-based and short-range (e.g. Bluetooth) accesses may be accessed by the interface means 103. The interface means may be capable of communicating with two or more different access types.

One or more applications in a device or apparatus such as the one illustrated in FIG. 1 may be configured to select a certain access type, for example by using profile-based access selection. The device or apparatus itself may also be so configured. If desired, non-profile based access selection may be employed. For example, an internet browser may be configured to select a WLAN access if such is available and if not, it may be further configured to check if a WCDMA access is available.

In profile-based access selection applications need not know the access types available, rather they may know the characteristics a selected access is desired to have. For example, an internet browser may require that a suitable access has a certain maximum price, preferably low, and simultaneously a certain minimum bandwidth, preferably high. In an exemplary embodiment, a profile may comprise one or more characteristics that determine at least in part the access. The characteristics of available accesses are then compiled and an access is selected based on a comparison between the required characteristics and the characteristics of available accesses. It is seen that profile-based access selection allows an access to be selected in a much broader set of circumstances, as the application need not know the names of any access types.

An algorithm may be defined or used to select an access that best fits a defined profile. Furthermore, if more than one access matches a defined profile then prioritization may be used to select an access. In an approach that uses a filter-based method, the requirements in a profile are treated as filters, and an access is selected from the available accesses based on how well the available accesses match the filters. In a fuzzy algorithm the requirements contained in a profile define an optimal point in an N-dimensional space (N is the number of requirements), and the selected access is the access from among the available ones, which is closest to this optimal point in the N-dimensional space. If desired, a filter-based and fuzzy algorithm may be employed jointly such that if the former fails, the latter is used. Additional or alternative methods for selecting an access based at least in part on a defined characteristic may be used, if desired.

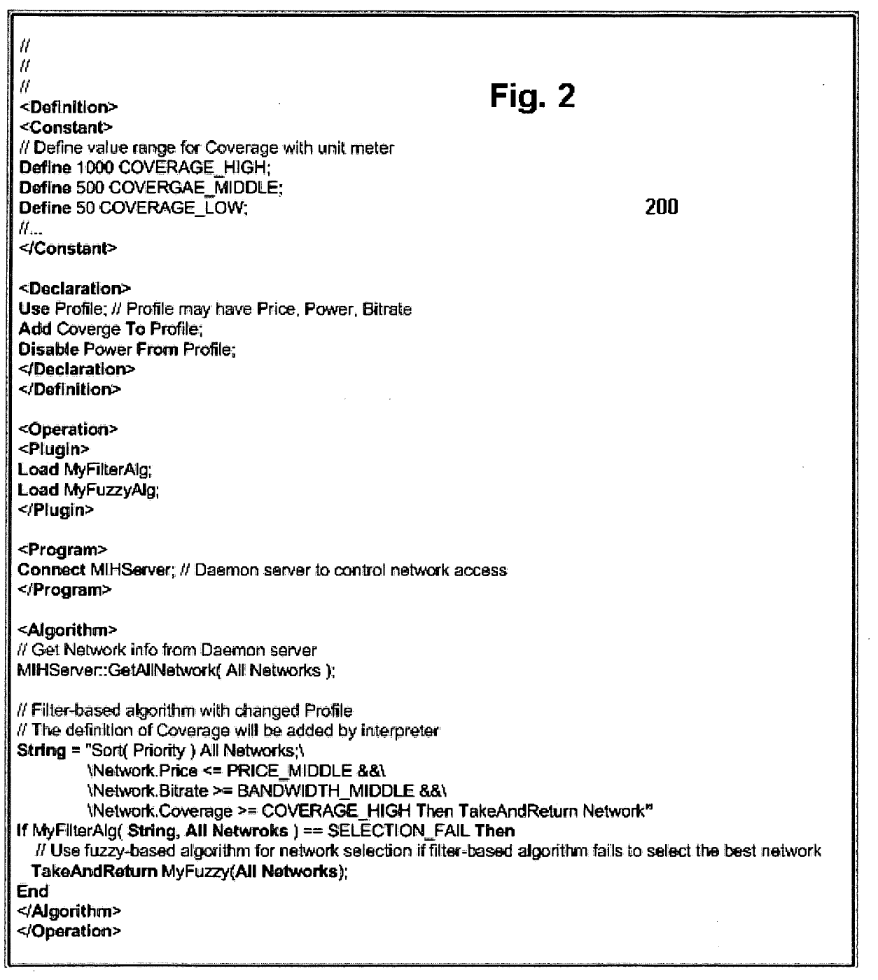

FIG. 2 illustrates an example of a programmable access selector in interpretable and executable script format. The exemplary script 200 comprises definitions for numerical values relating to access characteristics, for example COVERAGE_HIGH corresponds to the value 1000. The exemplary script further comprises interfaces to selection algorithms which are thus included in the access selector by invocation. The exemplary script yet further comprises program statements providing logic to perform access selection. In the example of FIG. 2, the selector will, when executed, obtain a list of all available accesses and compile a list of the available accesses which satisfy requirements relating to price, bandwidth and coverage. The selector will attempt to use a filter-based algorithm to select an access from among this list. If a filter-based algorithm fails to select an access, a fuzzy algorithm may be used to select an access from among the list.

It should be appreciated that the logic described in FIG. 2 is exemplary and the invention is not limited thereto. Since the access selector is programmable, a suitable logical construction may be defined so that an application may receive an optimal access of optimal type when the access selector is invoked. Parameters the selector may use include cost, power consumption, bitrate, coverage, range, remaining battery power, QoS availability as well as contractual matters. An example of QoS availability is that one access may offer conversational-type connectivity whereas another may lack this kind of quality guarantee. An example of contractual matters is that a user may have a special membership subscription with certain access providers, such that he gains credits for using services of these access providers. If desired, an application may provide a characteristic of a resource such as a destination address when accessing a resource on a network. This may be useful in situations where e.g. a corporate intranet is being accessed and it is more accessible via e.g. a nationwide cellular access provider than a local WLAN hotspot. In such a situation the destination resource may be specified to the programmable access selector such that it will affect the access selection when the programmable access selector is executed on a processor. The programmable access selector may be modifiable by a user, for example by using an editor or a suitable user interface. In certain embodiments, also other than filter-based and/or fuzzy-based algorithms may be applied. Those algorithms may implement an interface, be compiled into executable form and be installed in a device.

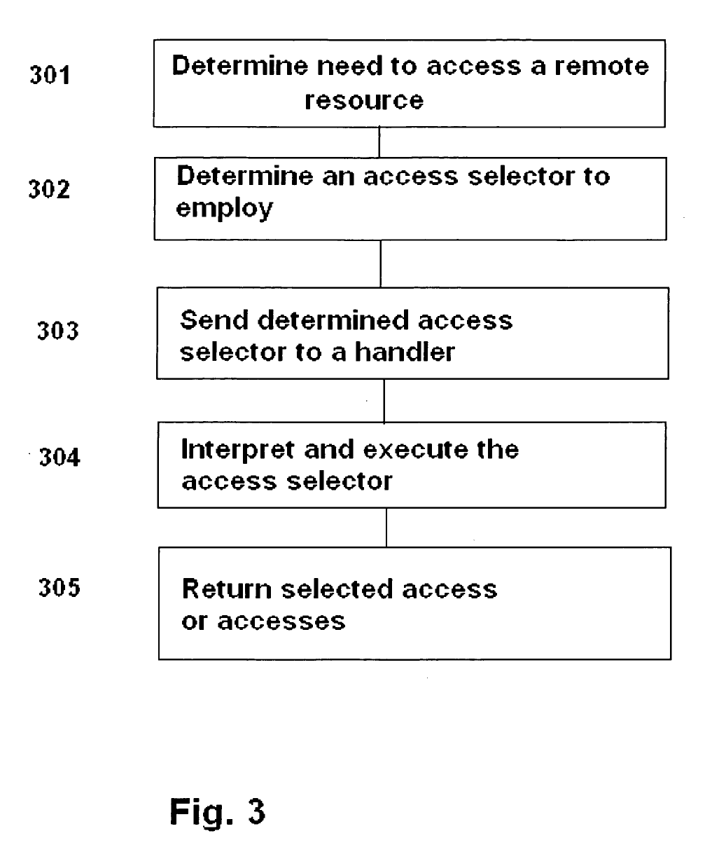

In FIG. 3 is illustrated an example of a process for selecting an access according to an exemplary embodiment of the present invention. At block 301 it is determined that an application requires access to a resource that is not locally available. An example is that the user of a mobile device invokes a function of his device to download email from a remote email server. Other examples include detecting a need to update presence information, access a remotely stored file or receive streaming media such as news broadcasts. A further example is that the user indicates he wishes to place a voice or video call with his mobile device or that the device is the terminating end of such a call.

At block 302 a programmable access selector is chosen from possibly several available. As an example, the programmable access selector determined may be a default selector of the device, an application-specific selector or a selector chosen according to the exact function the user has invoked. For example, the uniform resource locator URL of a requested internet resource may either affect the programmable access selector chosen, or this parameter may be passed to the programmable access selector as a variable. Parameters treated similarly may include the present user of the device and whether the device is in a home network or roaming.

At block 303 the access selector is sent or referred to a handler for execution. At block 304 the access selector is executed by the handler which interprets its contents and executes the logic contained therein. The handler may take the logical operations defined in the access selector and call other programs or libraries if any are defined in the access selector. At block 305 an access, or accesses is so defined, is returned as a return value resulting from the execution. In detail the handler, when executing the selector, may compile lists of available accesses by applying profiles stored in the selector, wherein the profiles may comprise defined characteristics of various accesses and access types which may be used to arrange, prioritize and/or prune lists of available accesses. Selection algorithms also stored in the selector, explicitly or by reference, may be applied to the accesses, or lists thereof, such that the profiles and algorithms are jointly used to select at least one access that is returned from the selector as a result of its execution, block 305. At least one profile and at least one algorithm may be comprised as parts of one unit.

A programmable access selector may be executed when an application requires access to a remote resource. It may also be executed before this with the resulting access selection being stored in a suitable data structure in a memory, from where an application may fetch the resulting access when a need for accessing a remote resource is determined.

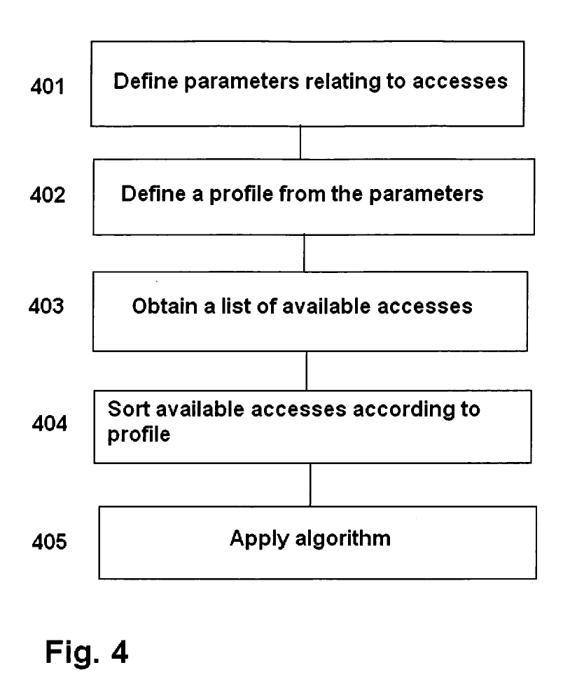

FIG. 4 illustrates a flowchart of an exemplary embodiment of a process to select an access. At block 401 one or more parameters relating to characteristics of accesses are defined. At block 402, at least one parameter is collected to form a profile. The parameters in the profile may be arranged according to priority. At block 403, a list of available accesses is obtained, for example by scanning frequencies or by receiving the list from a service. In an exemplary embodiment, the list of available accesses is received from a wireless network responsive to a mobile device providing the network an estimate of its geographic location. At block 404 the list of available accesses is sorted by applying the profile. At block 405 a selection method or algorithm is applied to the sorted list of available accesses. Block 405 may be optional, and/or it may involve using a filter-based or fuzzy algorithm. If desired, the different functions discussed herein may be performed in another order and/or concurrently with each other. Furthermore, if desired, one or more of the above-described functions may be optional or may be combined. For example the list of available accesses may be obtained before the defining of the profile takes place.

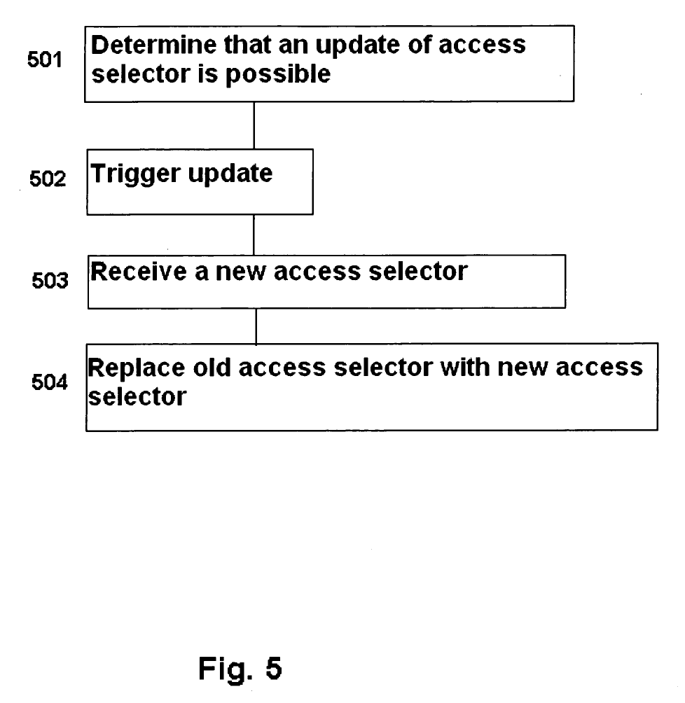

FIG. 5 illustrates an example of a process to update a programmable access selector. Since the programmable access selector is an executable program module, it may be replaced or updated by another one without disturbing other program modules. For example, an older version of a programmable access selector may be replaced by a newer version cognizant of new or changed characteristics of existing accesses, or characteristics of new accesses that have become available. If desired, only certain portions of the programmable access selector may be updated without affecting other parts.

As described in FIG. 5 at block 501, it is first determined that an update to an existing access selector is possible or available. In an exemplary embodiment it is determined, that an update may be needed, and/or that an updated access selector is available. This may be achieved, for example, by comparing a version number of a programmable access selector in a device with a version number received from a network. It may also be achieved by determining that there is at least one access characteristic defined for an access, that the device does not recognize or that an application issues requirements for a characteristic not recognized by the device. If desired, checking that an updated access selector is available may be needed, and may comprise sending a query to a database of access selectors or searching for access selectors online. It is then decided if the update will be performed. This decision may be taken in the device hosting the access selector or the update may be pushed from an access operator, for example to make mobile devices capable of utilizing a new feature of the access offered by the operator. In particular, a cellular operator may enhance its network by upgrading software and/or hardware and then push updates to programmable access selectors of subscribers, so that the mobile devices of the subscribers can access new features made possible by the upgrade in a logical way. The update may be conducted OTA. If done on the device, the the user may be presented with a yes/no query concerning the update. The update may be subject to a charge.

If the decision is taken to perform an update, block 502, the update is triggered. A new access selector or part thereof is subsequently received in the multi-access device at block 503. At block 504 the old access selector or part thereof is replaced by the newly received access selector or part thereof. The old access selector or part thereof may be either deleted or archived in the device, in case roll-back to the previous access selector becomes necessary or desirable. If desired, at block 503 only a portion of the access selector comprising updates may be received by the device. In this case, at block 504 relevant parts of the access selector may be updated.

Updating programmable access selectors as described in relation to FIG. 5 may be used to improve the adaptability of embodiments of the present invention to changing accesses or to changing requirements issued by applications concerning accesses.

It may be possible to update also only part of a programmable access selector, for example by replacing only an algorithm and leaving the profile and associated logic unchanged, or for example only updating a portion of a profile.

It should be clear to the skilled person, that several of the examples described above may be combined with each other without departing from the scope of the present invention and certain variations of the presented embodiments will fall within the scope of protection.

Embodiments of the invention may provide alternative or improved adaptation to changes in access characteristics or changes in requirements issued by applications. This may involve several aspects: a new type of access may have a novel type of characteristic an existing profile cannot utilize in selection, the number of parameters in a profile may change and the change may confuse a selection algorithm, new applications (e.g. a new browser) may benefit from different access characteristics when compared to old applications (e.g. an older browser), and finally new kinds of selection algorithms may be developed.

Without in any way limiting the scope, interpretation, or application of the claims appearing below, it is possible that a technical advantage of one or more of the exemplary embodiments disclosed herein may be that access selection becomes more efficient.

What is claimed is:

1. An apparatus, comprising:
a programmable access selector and a processor, wherein the programmable access selector comprises
at least one characteristic of at least one access;
at least one method to select at least one access, and
wherein the programmable access selector is configured to select from a plurality of available accesses based at least in part on said at least one method and said at least one characteristic.

2. The apparatus according to claim 1, wherein the programmable access selector is configured to be executable without compiling.

3. The apparatus according to claim 1, wherein the programmable access selector is implemented in a script language.

4. The apparatus according to claim 1, wherein the programmable access selector is configured to be executed by a handler.

5. The apparatus according to claim 1, wherein the programmable access selector is configured to be updatable.

6. An apparatus according to claim 1, wherein the at least one characteristic and the at least one method are parts of one unit.

7. The apparatus according to claim 4, wherein the apparatus is a mobile device and the programmable access selector is configured to be updatable over the air.

8. The apparatus according to claim 7, wherein the programmable access selector is configured to be updatable over the air in push fashion without input from a user of the mobile device.

9. The apparatus according to claim 1, wherein the at least one characteristic comprises at least one of the following characteristics: cost, power consumption, bitrate, coverage, range, remaining battery power, QoS availability and at least one contractual matter relating to said access.

10. The apparatus according to claim 1, wherein the at least one method is one of a filter-based algorithm and a fuzzy algorithm.

11. The apparatus according to claim 1, wherein the programmable access selector is associated with a characteristic of a remote resource.

12. The apparatus according to claim 1, wherein the programmable access selector accepts a characteristic of a remote resource as a parameter.

13. A method comprising:
obtaining a list of at least one of a plurality of available accesses;
comparing at least one defined characteristic to a corresponding characteristic of at least one of said plurality of available accesses, and
applying at least one method defined in a programmable access selector to said plurality of available accesses, wherein at least one access from the plurality of available accesses is selected responsive to applying the at least one method with the comparison.

14. The method according to claim 13, wherein the method is applied with the comparison either concurrently or subsequently.

15. A method according to claim 13, wherein the at least one defined characteristic comprises at least one of: cost, power consumption, bitrate, coverage, range, remaining battery power, QoS availability and at least one contractual matter relating to an access.

16. The method according to claim 13, wherein the obtaining comprises sending a geographic location to a network and receiving the list from the network responsive to said sending the geographic location.

17. The method according to claim 13, wherein the method is one of the following: a filter-based algorithm and a fuzzy algorithm.

18. The method according to claim 13, wherein the programmable access selector is associated with a characteristic of a remote resource.

19. The method according to claim 13, wherein the programmable access selector accepts as a parameter a characteristic of a remote resource.

20. A method, comprising:
determining that an update of an existing programmable access selector is possible;
triggering an update;
receiving at least a part of a new programmable access selector, and
replacing at least a part of said existing programmable access selector with the received at least part of said new programmable access selector.

21. The method according to claim 20, wherein the determining comprises at least one of the following:
comparing a version number of a first programmable access selector in a device with a version number received from a network;
determining that there is at least one access characteristic defined for an access that a device does not recognize, and
determining that an application issues a characteristic not recognized by a device.

22. The method according to claim 20, wherein the updating is performed to a mobile device over the air.

23. The method according to claim 22, wherein the updating is pushed by a wireless network the mobile device is configured to attach to.

24. The method according to claim 23, wherein the updating is subject to confirmation by the user and subject to charge.

25. An apparatus comprising:
a programmable access selector and processor means, wherein the programmable access selector comprises
at least one characteristic of at least one access;
at least one method to select at least one access, and
wherein the programmable access selector is configured to select from a plurality of available accesses based at least in part on said at least one method and based on the at least one characteristic.
